(19) United States
(12) Patent Application Publication
(10) Pub. No.: US 2005/0174662 A1
(43) Pub. Date: Aug. 11, 2005

(54) Adjustable mirror device

(76) Inventor: Mark Cozad, Huntington, IN (US)

Correspondence Address: Benjamin B. Cotton;Brinks Hofer Gilson & Lione, NBC Tower. Suite 3600, P.O. Box 10395, Chicago, IL, 60610, US

(21) Appl. No.: 10/775,622

(22) Filed: Feb. 10, 2004

(51) Int. Cl. G02B 7/182

(52) U.S. Cl. 359/872; 359/879

(57) ABSTRACT

The disclosed adjustable mirror device is used to increase the ability of the user to view objects when the user otherwise has a limited scope of view because as a result of an injury or the like. The adjustable mirror device is attached to a structural member of a medical halo, wheelchair or other device in order to provide additional viewing scope to the user. The adjustable mirror device includes a plurality of articulating joints that result in a plurality of degrees of freedom to allow the adjustable mirror device to be adjusted to meet the needs of the user.

### TECHNICAL FIELD

The present invention relates to the field of reflective devices to improve scope of sight, and more particularly to an adjustable mirror device.

### BACKGROUND OF THE INVENTION

A halo is a medical device that is typically used on a patient that has suffered a sever injury in the neck area such that immobilization of the neck and head are necessary. The halo is a cervical brace to prevent nearly all movement of the neck so as to allow for proper healing. The halo is used after complex spinal surgery when there is an unstable cervical fracture. The halo generally consists of a circular ring that attaches to a person's head, and secured to the skull with four screws or pins. The ring is then attached to four posts that are, in turn, connected to a vest that is fitted about the shoulders and chest of the user. The vest is worn at all times until the spinal injury has healed. The halo limits the movement of the head and neck of the wearer to the point that the person is required to turn their entire body in order to view objects behind them. Because the surgery and healing process generally generates a great deal of pain and soreness to the individual, such movements create discomfort and are often awkward or difficult to perform. Thus, the injured person has limited physical range of motion, and their vision is limited to direct sightlines and peripheral vision. Other personal injuries occur that also limit the physical movement of an individual, such as paraplegia or quadriplegia. Often, these individual are confined to wheelchairs, and the individual has similar limited physical range of motion.

In the prior art, the use of side and rear-view mirrors on automobiles is well known. These mirrors provide the driver with an increased view of the road by allowing the driver to see vehicles that are beside and behind their own vehicle without the need for the driver to completely turn their head for direct visual contact with the other automobiles or objects. It is also known in the prior art that similar mirrors can be attached to a bicycle helmet to allow the cyclist to view automobiles approaching from behind, thereby providing a safety mechanism to the cyclist.

### SUMMARY OF THE INVENTION

While these prior art devices fulfill their respective, particular objectives and requirements, they provide a limited amount of increased vision to the user. In this respect, the adjustable mirror device of the present invention departs from the prior art and allows the user a complete view of their surroundings by providing multiple degrees of movement of an adjustable mirror. The adjustment capabilities of the mirror device of the present invention allow the user to see above, below, peripherally, and behind them with the simple adjustment of the mirror device and without any requisite movement of the head or neck.

According to a first aspect of the present invention, an adjustable mirror device is provided. The mirror device includes an elongated adjusting rod, a clamping assembly and a mirror assembly. The clamping assembly is attached to a distal end of the adjusting rod, and the clamping assembly includes first and second clamping members configured to be actuated relative to each other. The mirror assembly is likewise attached to the adjusting rod and further includes a mirror and at least one articulating joint defining at least one degree of movement relative to the adjusting rod.

According to another aspect of the present invention, an adjustable mirror with a clamping assembly, an elongated adjusting rod and a mirror assembly is provides. The clamping assembly includes a pair of opposed clamping members, and each clamping member has a corresponding cut-out adapted to receive a structural member. A u-shaped collar is disposed about the adjusting rod, and a threaded bolt with a finger grip connects the opposing ends of the collar and both of the clamping members. The mirror assembly includes a laterally extending arm, and a transverse arm that is attached to the backing of a mirror. The connections between the laterally extending arm and the transverse arm and between the transverse arm and the backing each defines an articulatable joint providing at least one degree of movement of the mirror relative to the adjusting rod.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a front perspective view of an adjustable mirror device of the present invention secured to a medical halo;

FIG. 2 is a perspective view of one embodiment of the adjustable mirror device of FIG. 1;

FIG. 3 is an expanded view of an embodiment of the clamping assembly thereof;

FIG. 4 is an alternative embodiment of a portion of the mirror assembly thereof; and,

FIG. 5 is a front view of the mirror assembly of FIG. 2.

### DETAILED DESCRIPTION OF THE DRAWINGS AND THE PRESENTLY PREFERRED EMBODIMENTS

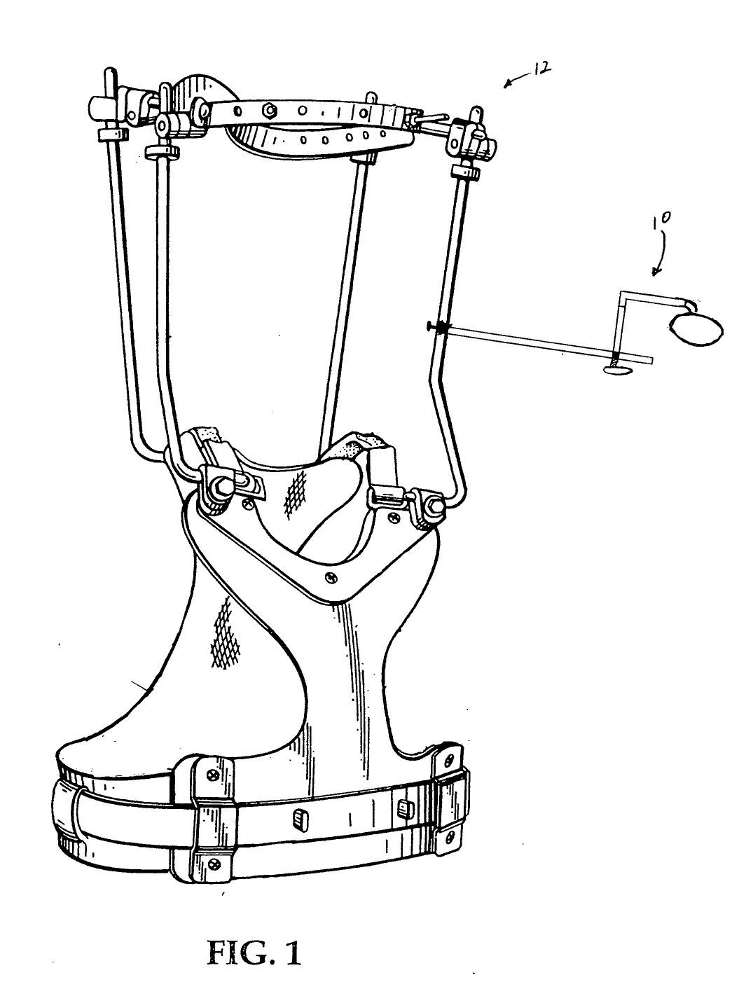

FIG. 1 illustrates an exemplary embodiment of an adjustable mirror device 10 attached to a medical halo 12. The mirror device 10 is configured to be rotatably and translationally adjustable with respect to a user's scope of vision in order to maximize the peripheral vision, provide substantial rearward sight capabilities, and provide directed vision to the user. In the preferred embodiment, the mirror device 10 is attached to a medical halo 12 device that is secured to a person's body in order to stabilize the head and neck area, usually after a traumatic event that requires little or no movement of the head so as to allow proper healing. The mirror device 10 has a plurality of articulating joints that provide several degrees of rotation and translational adjustment in order to personalize the viewing needs of each user. It should be understood by one skilled in the art that while the description below is in terms of attaching the mirror device 10 to a medical halo, the mirror device can also be secured to a variety of devices, such as a wheelchair, helmet or the like, in which the user has limited range of movement of the head in the same manner.

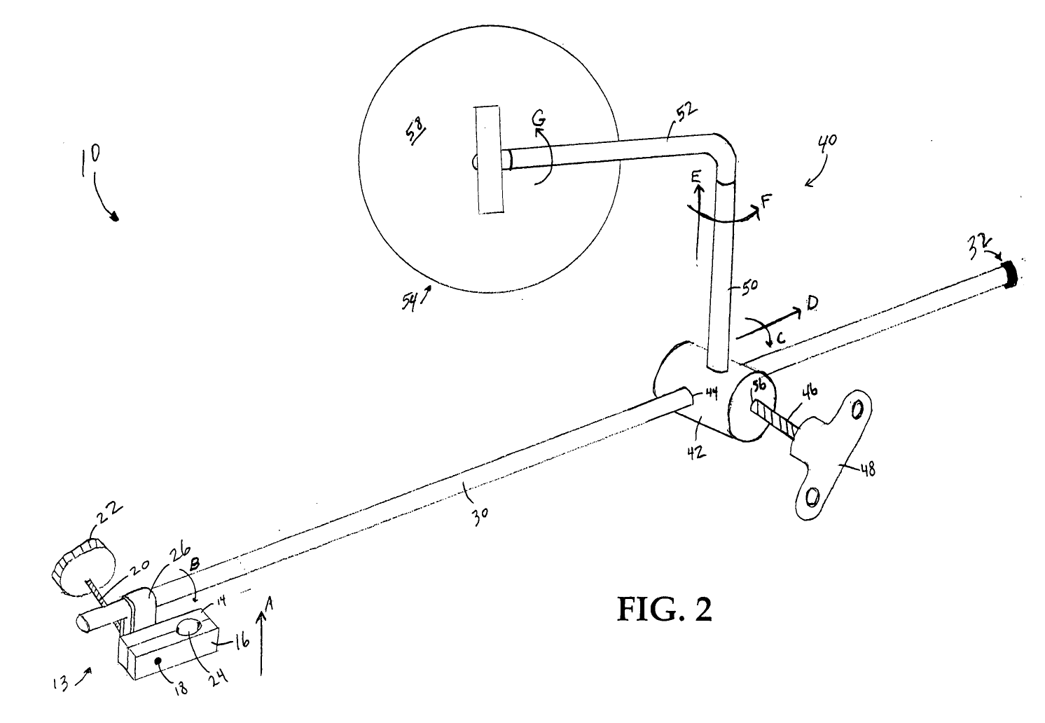

In the preferred embodiment, as shown in FIG. 2, the mirror device 10 includes an adjustable clamping assembly 13 disposed at a distal end of an elongated adjusting rod 30 and a mirror assembly 40 adjustably secured to the adjusting rod 30 such that the mirror assembly 40 can axially translate along the length of the adjusting rod 30 as well as rotate about the adjusting rod 30.

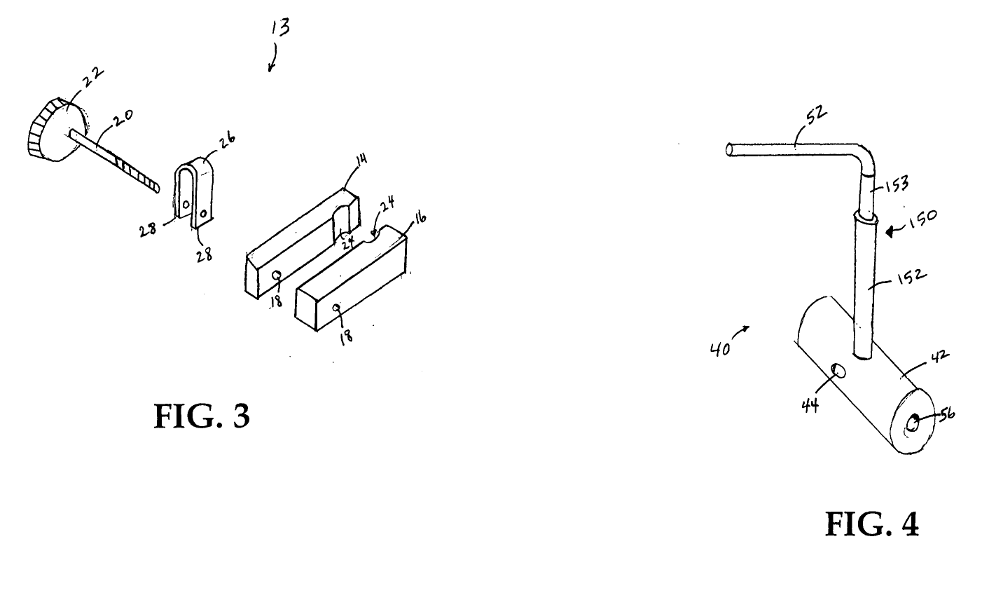

The clamping assembly 13 provides a removable connection between the adjusting rod 30 and the medical halo 12, as shown in FIG. 3. The clamping assembly 13 includes a pair of opposing, elongated clamping members 14, 16, wherein the clamping members 14, 16 are adjustable relative to each other. The surface of each clamping member 14, 16 directed toward the opposing clamping member moves toward and away from the opposing surface when the clamping members 14, 16 are actuated. Each clamping member 14, 16 has a hole 18 located at one end such that the hole 18 is directed transverse the longitudinal axis of the clamping member. The holes 18 of the clamping members 14, 16 are aligned in a manner to receive a threaded bolt 20 having a finger grip 22. The threaded bolt 20 is inserted through the hole 18 in the first clamping member 14, wherein the first clamping member 14 is free to move independently with respect to the rotation of the threaded bolt 20. The second, opposing clamping member 16 receives the distal end of the threaded bolt 20 opposite the finger grip 22. The hole 18 of the clamping member 16 is likewise threaded and in threaded engagement with the threaded bolt 20. Thus, the finger grip 22 allows the user to rotate the threaded bolt 20 in order to actuate the second clamping member 16 toward and away from the first clamping member 14, thereby engaging or releasing the clamping assembly 13 from a structural member of the halo 12. The rotation of the threaded bolt 20 actuates the second clamping member 16 relative to the first clamping member 14.

In an alternative embodiment, the threaded bolt is inserted through the hole in the first clamping member and is secured in the threaded hole of a second clamping member in a manner that when the bolt is rotated, the second clamping member remains substantially stationary relative to the bolt while the first clamping member translates along the length of the bolt toward and away from the second clamping member. In a further alternative embodiment, the first and second clamping mechanisms can be oriented such that one end of both clamping members are flexibly connected at a corresponding distal end, thereby forming a v-shaped clasp, wherein the rotation of the bolt actuates the distal ends of the clamping members opposite the flexible connection toward and away from each other in a clasping manner. In yet a further alternative embodiment, instead of a threaded bolt with a finger grip, a linear spring element is inserted through the holes in the opposing clamping members, and the spring biases the clamping members toward each other in a clamping manner. The user pulls the second clamping member away from the first clamping member axially along the linear spring in order to release the clamp. It should be understood by one skilled in the art that any other clamping or securing device that is sufficient to create a substantially rigid connection between the mirror device and the medical halo can be used.

Each clamping member 14, 16 further includes a semi-circular cut-out 24 located along the edge directed toward the opposing clamping member, as illustrated in FIG. 3. The cut-out 24 is disposed near the end opposite the hole 18, and is configured to receive a structural member of the medical halo 12. The cut-out 24 is transversely oriented with respect to the length of the clamping members 14, 16 as well as transversely oriented with respect to the length of the threaded bolt 20. The opposing cut-outs 24 of the clamping members 14, 16 are configured to surround a structural member of halo 12 in order to provide a secure, substantially rigid connection between the mirror device 10 and the halo 12. It should be understood that the cut-outs 24 of the clamping members 14, 16 can be of any shape sufficient to provide a substantially rigid connection between the clamping assembly 13 and the halo 12 or other medical device to which it is attached. The ability for the clamping assembly 13 to be released, relocated, and secured at various locations on a structural member of the halo 12 provides the mirror device 10 with a first degree of movement relative to the halo 12, illustrated as A in FIG. 2.

The clamping assembly 13 is secured to the adjusting rod 30 by an adjustable collar 26 that allows for rotation of the clamping assembly 13 relative to the adjusting rod 30, as illustrated in FIG. 2. As shown in FIG. 3, the collar 26 is a substantially u-shaped structure configured to encircle a substantial portion of the circumference of the adjusting rod 30. The ends of the adjustable collar 26 are disposed between the finger grip 22 and the first clamping member 14 of the clamping assembly 13, wherein the threaded bolt is inserted through holes in the ends 28 of the u-shaped collar 26. In operation, as the finger grip 22 is rotated the second clamping member 16 is actuated toward the first clamping member 14, and simultaneously forces the ends 28 of the collar 26 toward each other. As a result, the clamping members 14, 16 are secured about the halo 12 and the movement of the ends 28 of the collar 26 toward each other grips the adjusting rod 30, thereby preventing rotation of the clamping assembly 13 relative to the adjusting rod 30. The ability for the adjusting rod 30 to rotate relative to the clamping assembly 13 defines a first articulating joint and provides the mirror device 10 with a second degree of movement relative to the halo 12, illustrated as B in FIG. 2.

As illustrated in FIGS. 1 and 2, the adjusting rod 30 is secured to the halo 12 at one distal end by the clamping assembly 13 and also provides a defined path along which the mirror assembly 40 can translate. In the preferred embodiment, the adjusting rod 30 is a solid metal rod having a three-eighths inch circular diameter and an eleven inch length. It should be understood by one skilled in the art that the adjusting rod 30 can be of any length or cross-section sufficient to allow sufficient translation of the mirror assembly 40 in order to provide the user with additional scope of viewing. It should also be understood by one skilled in the art that the adjusting rod can be made of any material, including, but not limited to, plastic, polymer, or any other flexible or non-flexible material capable of providing structural integrity to the mirror device between the clamping assembly and the mirror assembly. A stop 32 is located at the distal end of the adjusting rod 30 opposite the clamping assembly 13 to prevent the mirror assembly 40 from translating beyond the end of the adjusting rod 30.

The mirror assembly 40 of the mirror device 10 is connected to the adjusting rod 30, and can be translated to any user-selected point along the length of the adjusting rod 30 or rotated about the axis of the adjusting rod 30 by the user. As illustrated in FIGS. 2 and 4, the mirror assembly 40 includes a mounting member 42, a threaded rod 46 with a handle 48, a laterally extending arm 50, a transverse arm 52, and a mirror 54.

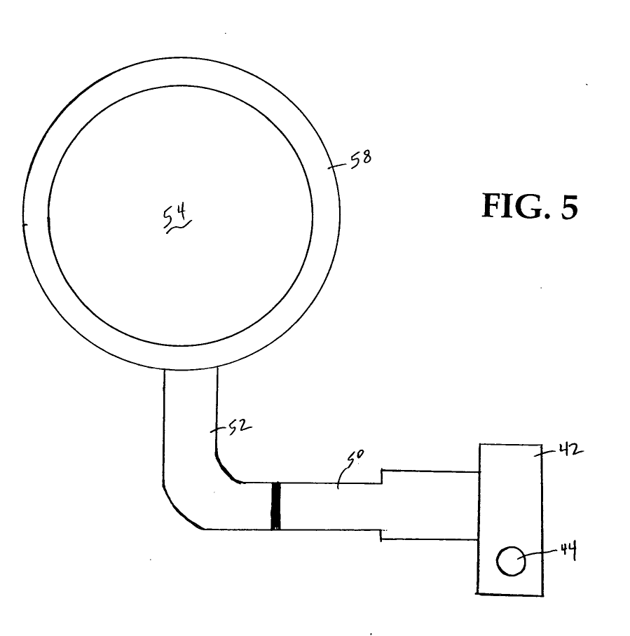

The mounting member 42 of the preferred embodiment of the mirror assembly 40, as illustrated in FIGS. 2 and 5, includes a hole 44 therethrough that corresponds with the cross-section of the adjusting rod 30. The mounting member 42 is capable of sliding along the length of the adjusting rod 30 to various user-selected positions. Additionally, the mounting member 42 is also capable or rotating about the axial length of the adjusting rod 30. The mounting member 42 further includes an aperture 56 that partially extends through the mounting member 42 in a direction transverse to the length of the adjusting rod 30 in a substantially perpendicular relationship with respect to the adjusting rod hole 44. The aperture 56 extends through the mounting member 42 and opens into the hole 44 for the adjusting rod 30. The threaded rod 46 is disposed through the aperture 56 to create an abutting relationship with the adjusting rod 30. The radial force from the threaded rod 46 upon the adjusting rod 30 secures the mounting member 42 in a selected position relative to the adjusting rod 30 by way of a frictional relationship. The mounting member 42 is prevented from freely sliding or rotating by a threaded rod 46 with a handle 48 disposed at one distal end, and the threaded rod 46 extends in the mounting member 42 in a direction transverse to the length of the adjusting rod 30. The handle 48 is configured to rotate the threaded rod 46 about its longitudinal axis as the user turns the handle 48.

In operation, the mounting member 42 is selectively positioned by the user at a selected point along the length of the adjusting rod 30 and the angle of the mounting member 42 relative to the adjusting rod 30 is similarly determined by the user. Once the user moves the mounting member 42 to the desired location, the handle 48 is rotated in a clockwise direction to actuate the threaded rod 46 into the aperture 56 until the end of the threaded rod 46 opposite the handle 48 abuts the adjusting rod 30. The frictional relationship between the threaded rod 46 and the adjusting rod 30 prevents undesired sliding or rotation of the mounting member 42 relative to the adjusting rod 30. To release the mounting member 42 whereby the user can vary the location or the angle of the mounting member 42, the handle 48 is turned in a counter-clockwise direction to separate the threaded rod 46 from the adjusting rod 30. The ability of the mounting member 42 to rotate and translate relative to the adjusting rod 30 defines a second articulating joint and provides the mirror device 10 with a third and a fourth degree of movement relative to the halo 12, illustrated as C and D in FIG. 2.

In an alternative embodiment, the outer radial surface of the adjusting rod 30 has a plurality of spaced-apart indentations about the circumference, thereby forming a rack. Instead of being connected to a threaded rod, the handle is attached to a spring-loaded adjusting pin, and the adjusting pin is configured to fit within the indentations of the rack, wherein the pin is biased into engagement with the rack. In operation, the user pulls the handle 48 in the direction of the pin away from the adjusting rod 30 to disengage the pin from the rack, thereby allowing the user to position the mounting member 42 at a selected location along the length of the adjusting rod 30. The biasing force of the spring connected to the pin also prevents rotation of the mounting member 42 relative to the adjusting rod 30 when the pin is engaged with the rack. In a further alternative embodiment, the handle 48 is connected to an elongated rod passing partially through the mounting member 42. The elongated rod has a pinion gear disposed at the end opposite the handle 48, whereby rotation of the handle 48 rotates the pinion gear which, in turn, meshes with the rack disposed on the adjusting rod 30. The rotation of the pinion gear selectively locates the mounting member 42 to a desired position along the length of the adjusting rod 30. It should be understood by one skilled in the art that any adjusting device can be used to allow the mounting member 42 to be selectively translated along the length of the adjusting member, as well as providing a securing force to prevent rotation of the mounting member 42 relative to the adjusting member.

In the preferred embodiment, a laterally extending arm 50 extends laterally from the mounting member 42 transverse to the length of the adjusting rod 30 in a substantially perpendicular relationship, as illustrated in FIG. 2. The laterally extending arm 50 is connected at one distal end to the mounting member 42, and at the opposing distal end provides a mounting surface adapted to receive the transverse arm 52 and allow rotation of the transverse arm 52 about the longitudinal axis of the laterally extending arm 50.

In an alternative embodiment, as illustrated in FIG. 4, the laterally extending arm 150 includes a stationary member 152 and a sliding member 153. The stationary member 152 is rigidly attached to the mounting member 42, thereby following the movements of the mounting member 42 relative to the adjusting rod 30. The sliding member 153 is disposed within a hole in the stationary member 152 adapted to receive the sliding member 153, wherein the sliding member 153 is extensible within the stationary member 152 in a telescopic manner. This sliding action allows for the sliding member 153 to be slidingly adjustable toward and away from the adjusting rod 30. While the sliding member 153 is secured within the stationary member 152 and allows sliding movement, the sliding member 153 can also rotate about the longitudinal axis of the stationary member 152. The sliding and rotational movement of the sliding member 153 relative to the stationary member 152 defines a third articulating joint and provides the mirror device 10 with a fifth and a sixth degree of rotation with respect to the halo 12, illustrated as E and F in FIG. 2. In a further alternative embodiment (not shown), the stationary member 152 is adapted to receive a sliding member 153 having a square cross-section, and the sliding member 153 is configured to slide axially relative to the stationary member 152.

A transverse arm 52 is connected to, and extends from, the distal end of the laterally extending arm 50 opposite the mounting member 42, as illustrated in FIGS. 2 and 5. The transverse arm 52 has a substantially parallel planar relationship with the adjusting rod 30 as the transverse arm 52 rotates relative to the laterally extending arm 50. The distal end of the transverse arm 52 opposite the distal end connected to the laterally extending arm 50 is configured to provide rotational movement of a mirror 54 about the longitudinal axis of the transverse arm 52. The rotation of the mirror 54 with respect to the transverse arm 52 defines a fourth articulating joint and provides the mirror device 10 with a seventh degree of rotation with respect to the halo 12, illustrated as G in FIG. 2.

The mirror 54 is preferably substantially flat with a backing 58 attached thereto, as illustrated in FIG. 2. The backing 58 includes a hole configured to receive a pin that rotatably connects the backing 58 of the mirror 54 to the transverse arm 52. It should be understood by one skilled in the art that any type of mirror 54 can be used, including, but not limited to, a convex or a concave mirror, depending upon the specific needs of the user.

In an alternative embodiment of the mirror device 10, the actuation of the each degree of rotation is performed by electronic motors controlled by an electronic controler in which the user chooses which portion of the device to rotate or translate and the degree to which it is actuated. The actuation command can be received from the user by way of a touchpad, selectable buttons and a joystick, or voice-operation. It should be understood by one skilled in the art that the actuation of each mechanism of the mirror device 10 can be actuated through a variety of methods configured to be adapted to the physical limitations of the user.

While preferred embodiments of the invention have been described, it should be understood by one skilled in the art that the invention is not so limited and modifications may be made without departing from the invention. The scope of the invention is defined by the appended claims, and all devices that come within the meaning of the claims, either literally or by equivalence, are intended to be embraced therein.

1. An adjustable mirror device comprising:
an elongated adjusting rod;
a clamping assembly attached to said adjusting rod; and
a mirror assembly attached to said adjusting rod, wherein said mirror assembly includes a mirror, said mirror assembly being slidable along an axial length of said adjusting rod and said mirror assembly being rotatable about said axial length of said adjusting rod.
